(19) United States
(12) Patent Application Publication
(10) Pub. No.: US 2012/0308454 A1
(43) Pub. Date: Dec. 6, 2012

(54) METHOD FOR REMOVING MERCURY FROM FLUE GASES OF HIGH-TEMPERATURE PLANTS

(75) Inventors: Josef Heuter, Koln (DE); Jürgen Wirling, Hurth (DE)

(73) Assignee: Rheinbraun Brennstoff GmbH, Koln (DE)

(21) Appl. No.: 13/514,771

(22) PCT Filed: Nov. 5, 2010
(86) PCT No.: PCT/EP2010/006752

§ 371 Date: Aug. 20, 2012

(30) Foreign Application Priority Data
Dec. 9, 2009 (DE) 10 2009 057 432.8

(51) Int. Cl. B01D 53/64

(52) U.S. Cl. 423/210

(57) ABSTRACT

The invention relates to a method for removing mercury from flue gases of high-temperature plants, in particular of power plants and waste incineration plants, in which method bromine and/or compounds containing bromine are added to the flue gas after firing in the flow direction. The flue gas is then subjected to at least one dry scrubbing process to remove the mercury and perhaps excessive bromine and/or excessive bromine compounds. The method according to the invention is characterized in that the bromine and/or the bromine compounds are brought in contact with the flue gas at a flue gas temperature ranging from 80° C. to 490° C., preferably from 80° C. to 250° C.

The invention relates to a method for removing mercury from flue gases of high-temperature plants, in particular of power plants and waste incineration plants, in which bromine and/or bromine-containing compounds are added to the flue gas in the direction of flow after the combustion chamber and then the flue gas is submitted to at least one dry scrubbing process to remove mercury and any excess bromine and/or excess bromine compounds.

Mercury and mercury compounds are always present in varying amounts in organic or fossil fuels. Through increasing burning of fossil fuels, more and more mercury is mobilized and accumulates in the biosphere. In view of the relatively high toxicity of mercury, and in particular of organically bound mercury, which is also ingested by humans directly or indirectly via the food chain, there are relatively strict limits for the legally permitted emissions of mercury for example from incineration plants and power plants.

Although for example in power plants and waste gas combustion plants and similar high-temperature plants operated in Germany, relatively low mercury concentrations in purified gas are already achieved, mainly owing to the wet scrubbing of flue gases that is the normal practice in Germany, there are continuing efforts to reduce mercury emissions, in particular owing to the high volume flows of flue gases, which have notable mercury loading.

Mercury occurs in incineration plants and coal-fired power stations essentially in two different forms: elemental mercury and oxidized divalent mercury. In contrast to gaseous elemental mercury, gaseous oxidized mercury is water-soluble and can therefore be washed out of the flue gas in a downstream flue gas scrubber. The oxidized form of mercury can also be removed better than elemental mercury in dry flue gas purification, for example using in-duct adsorption.

The commonest form of oxidized mercury is divalent mercury chloride. It forms during so-called mercury chlorination in boiler flue gas as it cools. The chlorine in the boiler flue gas originates from the fuel (e.g. chlorides contained in coal). In the hot combustion chamber, HCl forms first, and during cooling it is converted to Cl₂ in the so-called Deacon reaction. However, in the presence of SO₂, which forms from the sulphur contained in the fuel, this chlorine is converted back to HCl again by the so-called Griffin reaction and therefore is not available for oxidation of the mercury. At the boiler end of an incineration plant there is a ratio of oxidized mercury to elemental mercury that depends on the chlorine, sulphur and mercury content of the fuel. With a higher proportion of oxidized mercury, mercury can be removed more easily and better in the subsequent flue gas purification. Thus, it is desirable for oxidation of the mercury to be as complete as possible.

To achieve this, basically it is known to add halogens, in particular iodine or bromine, in the combustion process and/or to the flue gas stream and thus deliberately lower the concentration of elemental mercury in the gas stream.

So-called “bromine-assisted mercury separation” has proved especially suitable for decreasing elemental mercury in the flue gas stream.

A known method is described for example in DE 102 33 173 B4. In the process described there, bromine is added as a bromine compound (for example calcium bromide) in the combustion chamber or to the fuel (e.g. coal). Similarly to the reaction with chlorine described above, first there is formation of HBr in the hot combustion chamber (>1000° C.), and on cooling, this is converted to Br₂ in the “bromine Deacon reaction”. In contrast to chlorine, however, this Br₂ that has formed only reacts with sulphur dioxide at temperatures <100° C., so that the bromine is available for oxidation of the mercury throughout the boiler installation.

In the method according to DE 102 33 173 B4 it is therefore envisaged, in a multistage firing system, to introduce bromine and/or a bromine-containing compound and/or a mixture of various bromine-containing compounds into the combustion chamber and/or the flue gas in a section of the plant downstream of the furnace, wherein the temperature during contact of the bromine-containing compound with the flue gas should be at least 500° C. and combustion takes place in the presence of a sulphur-containing compound, in particular sulphur dioxide, with addition of sulphur and/or a sulphur-containing compound and/or a mixture of various sulphur-containing compounds, and the flue gas is then submitted to multistage scrubbing for removing mercury from the flue gas. As described above, this can easily be done by means of wet scrubbing.

This is also based on the knowledge that at comparable SO₂ content, oxidation with bromine is at least 25 times more efficient than oxidation with chlorine. The resultant oxidized mercury can easily be removed in wet scrubbing and can be precipitated in wash-water treatment.

A disadvantage of this known method is, among other things, the fact that in particular, addition of the bromine compounds in the combustion chamber only offers limited flexibility with respect to the flue gas conditions prevailing in each case or to variable flue gas conditions. Furthermore, the method is limited to later applications with wet scrubbers, because without the temperature drop in the scrubber, the toxically relevant bromine that formed in the process by the bromine-Deacon reaction is only removed partially, if at all, in the flue gas duct, and therefore enters the atmosphere in gaseous form. It has to be borne in mind that bromine, like mercury, is a highly toxic environmental pollutant. Many older coal-fired power stations, especially abroad, do not have wet scrubbers, so that restriction of the known method to high-temperature plants without downstream flue gas wet scrubbing is an exclusion criterion.

A method according to the introductory clause of claim 1 is known for example from U.S. 2009/0010828 A1. In the method known from document U.S. 2009/0010828, bromine-containing compounds for example in the form of bromomethane, bromoethane or bromopropane are added to the flue gas in the direction of flow after the combustion chamber. The bromine compounds are added to the flue gas at a flue gas temperature between 60° C. and 400° C., then the flue gas is submitted to purification to remove the mercury and any excess bromine. On the assumption that the thermodynamics for the oxidation of mercury is favourable in particular at lower temperatures, in the document the use of reactants such as bromomethane and bromoethane is proposed, which dissociate in particular at low temperatures. Dissociation takes place outside of the flue gas stream. The reactants are added to the flue gas stream in already dissociated form. For this, introduction of the reactants in the gas phase is essential, and is relatively expensive.

Another method for bromine-assisted removal of mercury from flue gas of a high-temperature plant is known for example from WO 2005/092476 A1. Hydrogen bromide is proposed as reactant in this method, and is brought into contact with the sorbents at temperatures of up to 50° C. The already doped sorbents are injected into the waste gas stream at temperatures <175° C.

The method is all the more expensive because prior doping of the adsorbents with hydrogen bromide is required. As an alternative to hydrogen bromide, Br₂ is mentioned as bromine compound in the document. Both hydrogen bromide and Br₂ are extremely toxic and highly corrosive, so appropriate precautions are absolutely essential for handling. Owing to the chemical properties of these substances, they are only to be handled in smaller units.

The problem to be solved by the invention is therefore to provide a method according to the introductory clause of claim 1 that can be carried out relatively easily and inexpensively and that is improved with respect to its adaptability to varying flue gas compositions and with respect to its range of applications.

This problem is solved by the features of claim 1.

An advantageous combination of bromine-assisted and adsorption-based mercury separation is envisaged according to the invention. It has been found that, contrary to the descriptions in the trade journals and in the prior art according to DE 102 33 173 B4, notable bromination of mercury is already possible at temperatures well below 500° C.

The mechanism of action can be explained by the dissociation of NaBr or of CaBr₂ to bromide anions, which takes place in the pore structure of activated carbon and in the presence of steam at temperatures below 500° C. The capillary structure of activated carbon or of hearth-furnace coke has a substantial influence on this, where in conjunction with water vapour present in the atmosphere, dissociation takes place, followed by oxidation to mercury bromide. The resultant mercury bromide is, in contrast to the method described in DE 102 33 173 B4, firmly bound in the activated carbon matrix and can be separated reliably in the downstream deduster.

It is envisaged according to the invention that the bromine and/or the bromine-containing compounds, mixed with carbon-containing adsorbents, preferably with activated carbon and/or activated coke, are brought into contact with the flue gas stream.

Alternatively, it is envisaged that bromine and/or the bromine compound are brought, upstream relative to the flue gas flow, into contact with carbon-containing adsorbents introduced in the form of a cloud of flue dust into the flue gas stream, preferably in the form of activated carbon and/or activated coke.

The method according to the invention has in particular the advantage, relative to the known methods, that the proportion of sulphur dioxide in the flue gas is not critical for the method.

In any case, competing reactions of the bromine with other substances contained in the flue gas are avoided because the bromine compounds are given up to the gas stream in the immediate vicinity of the adsorbents. Owing to an especially favourable combination of reaction-based and adsorption-based flue gas purification, the method according to the invention is not dependent on downstream wet scrubbing.

In a preferred variant of the method according to the invention it is envisaged that the spatial distance between the addition of bromine and/or bromine-containing compounds and the addition of adsorbents, measured as the temperature difference of the flue gas stream, is <410° C. In other words, the spatial distance between the addition of bromine and/or bromine-containing compounds in the flue gas stream after a combustion chamber is selected so that the flue gas stream does not cool by more than 410° C. between addition of bromine and addition of adsorbents. However, it is not ruled out according to the invention that the cooling of the flue gas stream for instance between addition of the bromine-containing compounds and addition of the adsorbents takes place using one or more heat exchangers.

The bromine and/or the bromine compounds are introduced in liquid or gaseous form into the flue gas stream.

In an advantageous variant of the method according to the invention, the proportion of bromine and/or bromine-containing compounds in the total amount of adsorbents and bromine and/or bromine compounds added can be between 3 and 14 wt. %, preferably between 5 and 12 wt. %.

For example all types of activated carbon and activated coke can be used as adsorbents, both individually and as a mixture. In an especially preferred variant of the method, brown coal cokes, preferably so-called hearth furnace cokes, are used as carbon-containing adsorbents.

With separate addition of the bromine and/or the bromine compound, sodium bromide or calcium bromide is introduced, preferably in liquid form, by injection into the flue gas stream, after a combustion chamber and before flue gas dedusting and any downstream flue gas desulphurization. If introducing a liquid bromine compound, for example calcium bromide (CaBr₂) may be considered as the bromine compound, and in the case of gaseous addition, for example hydrogen bromide (HBr) can be used.

Downstream of addition of the bromine compounds, carbon-containing adsorbents are then introduced in the form of a cloud of flue dust into the flue gas stream, wherein the distance between addition of the bromine compounds on the one hand and of the carbon-containing adsorbents on the other hand defines the reaction section available in the flue gas stream, over which bromination of the elemental mercury takes place in the flue gas stream. Addition of the bromine compounds preferably takes place at temperatures <500° C. and >250° C. Addition of the carbon-containing adsorbents in the form of a cloud of flue dust takes place at a temperature ≦250° C. Removal of the mercury bromide and of the excess bromine takes place via the carbon-containing adsorbents, which are removed from the flue gas stream in a downstream deduster. The usual electrostatic filters, cloth filters etc. may come into consideration as dedusters.

In the variant with separate addition of bromine on the one hand and adsorbents on the other hand, described above, the bromine injected into the flue gas stream is already available in the gas phase for oxidation of the mercury. In a further additional step, mercury separation or removal takes place on the activated carbon doped in the gas path.

In the method according to the invention, at least with separate addition of bromine and adsorbents or hearth-furnace coke, there is in situ doping of the carbon-containing adsorbents.

In the method according to the invention, the separate addition of calcium bromide or sodium bromide takes place in the liquid phase, or of hydrogen bromide in the gas phase, wherein the carbon-containing adsorbents form crystallization nuclei in the cloud of flue dust for the bromine compounds introduced into the flue gas stream.

As already mentioned at the beginning, the carbon-containing adsorbents and the bromine compounds can also be added as a mixture to the flue gas stream. In this case it is reasonable and desirable to add this mixture at temperatures ≦250° C. to the flue gas stream. For example, hearth-furnace coke can be mixed with sodium bromide or calcium bromide in liquid form or as salt. Depending on the composition of the flue gas, the adsorbents can be dosed in the range from 20 mg to 300 mg relative to one m³ of flue gas, preferably between 50 mg and 150 mg flue gas. The addition of sodium bromide or calcium bromide relative to the proportion of bromine in the mixture with the adsorbents is between 3 and 14 wt. %, preferably between 5 and 10 wt. %, depending on the mercury concentration in the flue gas.

1. A method for removing mercury from flue gases of high-temperature plants, in particular of power plants and waste incineration plants, in which bromine-containing compounds and carbon-containing adsorbents are added to the flue gas in the direction of flow after the combustion chamber and then the flue gas is submitted to at least one dry scrubbing process to remove mercury and any excess bromine compounds, wherein the bromine compounds are brought into contact with the flue gas at a flue gas temperature between 80° C. and 490° C., characterized in that sodium bromide and/or calcium bromide are used as bromine compounds and in that the bromine-containing compounds mixed with carbon-containing adsorbents or upstream relative to the flue gas flow, are brought into contact with carbon-containing adsorbents introduced in the form of a cloud of flue dust into the flue gas stream.

2. The method as claimed in claim 1, characterized in that the bromine compounds are brought into contact with the flue gas at a flue gas temperature between 80° C. and 250° C.

3. The method as claimed in claim 1, characterized in that activated carbon and/or activated coke are used as adsorbents.

4. The method as claimed in claim 3, characterized in that the spatial distance between the addition of bromine and/or bromine-containing compounds and the addition of adsorbents, measured as the temperature difference of the flue gas stream, is ≦410° C.

5. (canceled)

6. The method as claimed in claim 1, characterized in that the bromine and/or the bromine compounds are introduced in liquid or gaseous form into the flue gas stream.

7. The method as claimed in claim 1, characterized in that the proportion of bromine and/or bromine-containing compounds in the total amount of adsorbents and bromine and/or bromine compounds added is between 3 and 14 wt. %, preferably between 5 and 12 wt. %.
